(19) United States
(12) Patent Application Publication
(10) Pub. No.: US 2025/0335256 A1
(43) Pub. Date: Oct. 30, 2025

(54) AUTOMATIC RESOURCE ALLOCATION AND PARTITIONING OF HPC WORKFLOWS

(71) Applicant: Hewlett Packard Enterprise Development LP, Spring, TX (US)

(72) Inventors: Pedro Henrique Rocha Bruel, San Jose, CA (US); Alex Weaver, Milpitas, CA (US); Sai Rahul Chalamalasetti, Newark, CA (US); Aditya Dhakal, Santa Clarita, CA (US); Gourav Rattihalli, Milpitas, CA (US); Rolando Pablo Hong Enriquez, London (GB); Alok Mishra, Berkeley Heights, NJ (US); Dejan S. Milojicic, Palo Alto, CA (US)

(21) Appl. No.: 18/649,709

(22) Filed: Apr. 29, 2024

(51) Int. Cl. G06F 9/50

(52) U.S. Cl. CPC G06F 9/5038; G06F 9/5044; G06F 2209/5019; G06F 2209/5021; G06F 2209/503

(57) ABSTRACT

A method includes receiving a user-submitted workflow comprising a plurality of kernels. The method further includes padding at least one kernel of the user-submitted workflow with at least one profiling tag and executing the user-submitted workflow on a compute node. The method further includes receiving at least one metric from the workflow during execution of the workflow according to the at least one profiling tag and training a reinforcement learning agent according to the at least one metric, wherein the reinforcement learning agent determines a suggested action for a particular type of kernel according to the at least one metric. The method further includes utilizing the suggested actions in making a scheduling decision for performing a task associated with an unexecuted kernel within the plurality of kernels while the user-submitted workflow continues executing, wherein the scheduling decision comprises a computing resource allocation for executing the task.

### BACKGROUND

The amount of data in the world is exploding and meaningfully analyzing large data sets has become increasingly challenging. Computing and algorithm limitations associated with analyzing large data sets are felt in a wide range of areas including health care, meteorology, genomics, complex physics simulations, biological and environmental research, internet search, surveillance, photo/video archives, finance and business informatics, and other areas. In order to analyze large data sets, cloud-based computing, web services, function-as-a service, and other distributed processing systems have become increasingly common as means to process the workflows associated with these large data sets.

A cloud-based data center is an advanced computing environment that leverages a network of remote servers hosted on the internet to store, manage, and process data, rather than relying on local servers or personal computers. At the heart of this data center is the scheduler, a system that orchestrates the distribution and execution of workloads across the available compute and storage nodes. The scheduler ensures that resources are allocated efficiently, balancing the demands of various applications and services to optimize performance and minimize latency.

### BRIEF DESCRIPTION OF THE DRAWINGS

Aspects of the present disclosure are best understood from the following detailed description when read with the accompanying figures.

FIG. 1 is a block diagram of a computing system, according to some implementations.

FIG. 2 depicts a system for profiling and partitioning of workflows in a cloud environment, according to some implementations.

FIG. 3 provides a flowchart of a computer-implemented user-submitted workflow resource allocation method, according to some implementations.

FIG. 4 provides a flowchart of a method to train a learning agent, according to some implementations.

FIG. 5 is a schematic diagram of an example scenario for utilizing the disclosed systems and methods.

FIG. 6 provides a flowchart of a computer-implemented user-submitted workflow resource allocation and scheduling method, according to some implementations.

FIG. 7 provides a block diagram of a computer-implemented user-submitted workflow resource allocation and scheduling system, according to some implementations.

### DESCRIPTION

The following disclosure provides many different examples for implementing different features. Specific examples of components and arrangements are described below to simplify the present disclosure. These are, of course, merely examples and are not intended to be limiting.

Scientific as well as other types of workflows are executed on a variety of machines and runtime environments. For optimal execution of a workflow, the tasks of a workflow should be specifically tailored for each new environment. Although, a task may run efficiently on one type of machine or run time environment, this is no guarantee that the task will run efficiently on another type of machine or run time environment since a different machine or run time environment may utilize, for example, different Graphics Processing Unit (GPU) architectures, have a different number of Central Processing Unit (CPU) cores, a different number of accelerators, include a different communication bandwidth between accelerators, etc., than is provided by the machine in which it is known that a task runs efficiently. Furthermore, moving from High Performing Computing (HPC) clusters to an as-a-service paradigm (e.g., the cloud, a web service, a function-as-a-service) introduces additional factors like cost and throughput. Platform providers, who manage compute resources, desire to maximize throughput of workflows and minimize infrastructure cost. Additionally, workflow tasks are not guaranteed to launch in isolation. In fact, platform providers have an incentive to pack as many tasks onto available resources as possible. However, when tasks share resources, they can interfere and degrade overall performance and throughput. It is desirable to have systems and methods that substantially optimize resource utilization while substantially minimizing costs in order to improve the efficiency of workflows in an environment.

Various solutions have been proposed, many of which focus on workflow characterization offline and do not provide much meaningful insight, as the workflow characterization is stripped of its runtime context, while other solutions that provide online characterization of workflow do so by running incoming tasks in isolation to make scheduling decisions on an individual task level. Some current solutions predict the performance of an application for a new hardware configuration based on offline learning of the application's performance from the previous hardware configuration. Still other solutions provide an adaptive workflow profiler using machine learning. This adaptive workflow profiler solution is focused on creating a lightweight tool to decrease the computational overhead of profiling. The downside of this adaptive workflow profiler using machine learning is that this solution is mainly focused on in-situ memory data performance and is bound to suffer transferability issues because it uses workflow-specific metrics.

In contrast to previous solutions, disclosed herein are hybrid online/offline learning frameworks that profile workflow tasks during runtime given the current resource environment and provide immediate and relevant insights, such as predicted execution time, system load, and resource utilization, to the workflow manager and task scheduler. If a previously known workflow is submitted, a pre-trained offline workflow model is consulted in order to provide insight to the scheduler. If a new workflow is submitted, profiling tags are inserted into the code that extract various data related to various metrics that are useful in managing workflow and scheduling. The data extracted from the workflow as it is executing is provided to a reinforcement learning agent and the reinforcement learning agent is trained online with incoming task profiling data. After a new task is scheduled with online learning methods, the collected profiling data from the unknown workflow is used to train a new offline workflow model to be used in future submissions of the same task.

The disclosed methods and systems provide a number of benefits not provided by other solutions. For example, various disclosed methods and systems offer improved Quality-of-Service for HPC-as-a-Service across a wide variety of user-submitted tasks and workflows. Additionally, they decrease HPC-as-a-Service hardware cluster costs by effectively utilizing hardware, optimizing resource allocation, and minimizing idle time for compute resources. These benefits are achieved through a hybrid online/offline solution that allows unknown workflows to be profiled in real-time, extracting meaningful data during execution and utilizing the extracted data to make informed scheduling and management decisions for the workflow as it continues to execute.

As used herein, an operation occurring “online” means the operation is performed during execution of a workflow. Also, as used herein, an operation occurring “offline” means the operation is performed separately from execution of a workflow, such as before execution of the workflow.

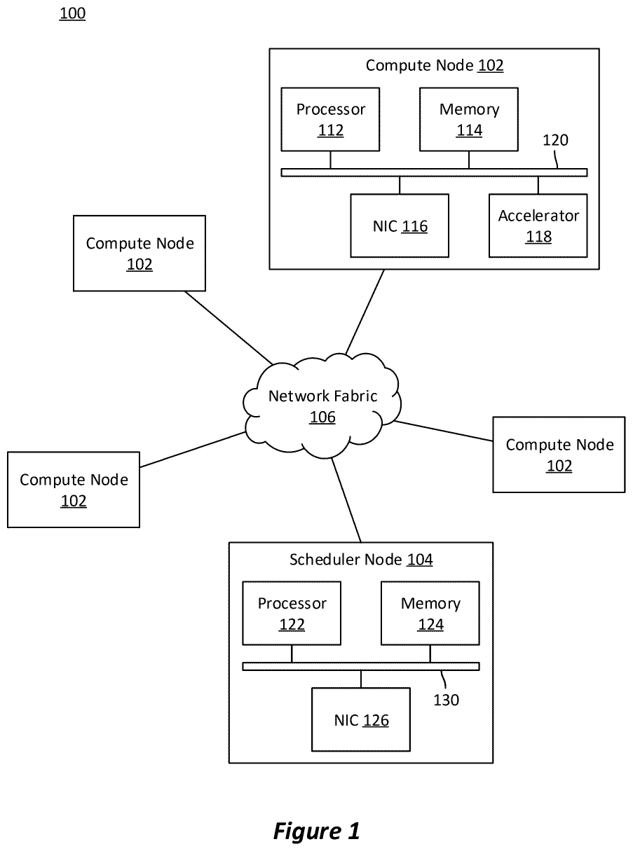

FIG. 1 is a block diagram of a computing system 100, according to some implementations. The computing system 100 may be part of a computing environment, such as an HPC environment, capable of parallel execution of computing processes, such as tasks of a workflow. The computing system 100 may utilize a client-server architecture. The computing system 100 includes multiple compute nodes 102, a scheduler node 104, and a network fabric 106.

The compute nodes 102 work together to perform HPC computations. For example, a workflow may be divided into smaller segments or tasks that may be parallelized across the compute nodes 102. Process(es) may be executed on the compute nodes 102 to perform the HPC computations. The compute nodes 102 may be implemented using any suitable combination of hardware, firmware, and software. For example, each compute node 102 may be a standalone unit equipped with a processor, memory, and the like (subsequently described).

An application may be executed using one or more compute nodes 102, which execute processing tasks, such as tasks of a workflow for execution in a potentially parallel manner. For example, these processing tasks may be assigned to the compute nodes 102 (e.g., by the scheduler node 104) as execution flows that involve the compute nodes 102 executing computer code, potentially in portions. To that end, the compute nodes 102 may execute one or more processes of the application, working together to execute the application.

The compute nodes 102 may (or may not) be similar to each other. Additional details of one compute node 102 are shown. The compute node 102 includes various hardware components. For example, the compute node 102 may include a processor 112, a memory 114, a NIC 116, and an accelerator 118. The hardware components may be interconnected through a number of busses and/or network connections. In one example, the processor 112, the memory 114, the NIC 116, and the accelerator 118 may be communicatively coupled via a bus 120, such as a PCI-Express bus.

The processor 112 retrieves executable code from the memory 114 and executes the executable code. The executable code may, when executed by the processor 112, cause the processor 112 to implement any functionality described herein. The processor 112 may be a microprocessor, an application-specific integrated circuit, a microcontroller, or the like.

The memory 114 may include various types of memory, including volatile and nonvolatile memory. For example, the memory 114 may include Random-Access Memory (RAM), Read-Only Memory (ROM), a Hard Disk Drive (HDD), and/or the like. Different types of memory may be used for different data storage needs. For example, the processor 112 may boot from ROM, maintain nonvolatile storage in an HDD, execute program code stored in RAM, and store data under processing in RAM. The memory 114 may include a non-transitory computer readable medium that stores instructions for execution by the processor 112. One or more modules within the compute node 102 may be partially or wholly embodied as software and/or hardware for performing any functionality described herein.

The memory 114 may include a kernel space and a user space. The kernel space may be a reserved area of the memory 114 for running an operating system kernel, kernel extensions, device drivers, and the like. The user space may be an area of the memory 114 for running code outside the operating system kernel and generally includes data for running software applications. For example, a task of a workflow may be an application executed by the processor 112, and data for the workflow task may be stored in the user space.

The NIC 116 may be used to connect to the network fabric 106 and communicate with other nodes over the network fabric 106. The NIC 116 facilitates the transmission and reception of data packets between the compute node 102 and other compute nodes 102 or the scheduler node 104 (via the network fabric 106), and may adhere to one or more networking standards such as Ethernet, Wi-Fi, and the like.

The accelerator 118 is a specialized processing unit that can be programmed to perform operations for an HPC computation. Examples of the accelerator 118 include Graphics Processing Units (GPUs), Field Programmable Gate Arrays (FPGAs), Application-Specific Integrated Circuits (ASICs), and other specialized processing units, which may be incorporated into the compute node 102 to expedite computations for workflow tasks. The accelerator 118 may include a streaming multiprocessor. The accelerator 118 provides significant computational power, allowing for faster execution of some tasks than a general-purpose processor (e.g., the processor 112).

The scheduler node 104 assigns tasks of a workflow to one or more compute nodes 102. Tasks may be scheduled based on a variety of factors (subsequently described), including the state of the compute nodes 102. The scheduler node 104 may monitor the state of the compute nodes 102 (e.g., compute utilization, memory utilization, etc.) and make task scheduling decisions based on the state of the compute nodes 102. Additionally, and as subsequently described in greater detail, a scheduler node 104 may attempt to identify a previously-run workflow, predict the system state with the given workflow, and determined scheduling information for the workflow accordingly.

The scheduler node 104 includes various hardware components. The scheduler node 104 may (or may not) include similar components as those described for the compute nodes 102. For example, the scheduler node 104 may include a processor 122, a memory 124, and a NIC 126. The hardware components may be interconnected through a number of busses and/or network connections. In one example, the processor 122, the memory 124, and the NIC 126 may be communicatively coupled via a bus 130, such as a PCI-Express bus.

The processor 122 retrieves executable code from the memory 124 and executes the executable code. The executable code may, when executed by the processor 122, cause the processor 122 to implement any functionality described herein. The processor 122 may be a microprocessor, an application-specific integrated circuit, a microcontroller, or the like.

The memory 124 may include various types of memory, including volatile and nonvolatile memory. For example, the memory 124 may include Random-Access Memory (RAM), Read-Only Memory (ROM), a Hard Disk Drive (HDD), and/or the like. Different types of memory may be used for different data storage needs. For example, the processor 122 may boot from ROM, maintain nonvolatile storage in an HDD, execute program code stored in RAM, and store data under processing in RAM. The memory 124 may include a non-transitory computer readable medium that stores instructions for execution by the processor 122. One or more modules within the scheduler node 104 may be partially or wholly embodied as software and/or hardware for performing any functionality described herein.

The memory 124 may include a kernel space and a user space. The kernel space may be a reserved area of the memory 124 for running an operating system kernel, kernel extensions, device drivers, and the like. The user space may be an area of the memory 124 for running code outside the operating system kernel and generally includes data for running software applications. For example, a workflow scheduler may be an application executed by the processor 122, and data for the workflow scheduler may be stored in the user space.

The NIC 126 may be used to connect to the network fabric 106 and communicate with other nodes over the network fabric 106. The NIC 126 facilitates the transmission and reception of data packets between the scheduler node 104 and the compute nodes 102 (via the network fabric 106), and may adhere to one or more networking standards such as Ethernet, Wi-Fi, and the like.

The network fabric 106 facilitates the coordination and synchronization of the compute nodes 102 and the scheduler node 104 when performing HPC computations. The network fabric 106 may include routers, switches, links, and the like. The components of the network fabric 106 work together to provide a high-bandwidth interconnection between the compute nodes 102 and the scheduler node 104. The design of the network fabric 106 may prioritize low latency and high throughput among the connected components. For example, the network fabric 106 may be based on a technology such as Ethernet, InfiniBand, or the like.

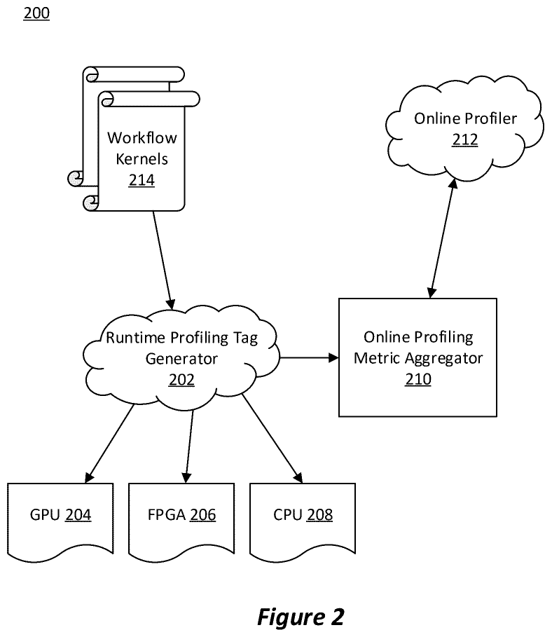

FIG. 2 depicts a system 200 for profiling and partitioning of workflows in a cloud environment, according to some implementations. The system 200 includes a runtime profiling tag generator 202, a plurality of GPUs 204, a plurality of FPGAs 206, a plurality of CPUs 208, an online profiling metric aggregator 210, an online profiler 212, and a plurality of workflow kernels 214 from a user-submitted workflow. Functionality of the system 200 may be implemented by a workflow scheduler running on the scheduler node 104 described for FIG. 1.

A workflow includes multiple workloads or tasks, and each workload may include a plurality of different workflow kernels 214 that are run at various places. A workload or task within a workflow may be a computer program that is run from start to finish, often consisting of multiple kernels. Kernels can be thought of as individual functions or operations within a task that are executed on computational resources such as CPUs or accelerators like GPUs. The workflow classifier incorporates knowledge about the entire workflow, aggregating data from all tasks and their interdependencies, rather than just evaluating individual tasks or workloads. Typically, kernels 214 are launched for a workflow asynchronously to a CPU. For example, and referring back to FIG. 1, a processor 112 may launch kernels for a workflow on an accelerator 118. A kernel graph may be used to launch kernels one after another and to maintain dependencies.

If the workflow kernels 214 are from a known workflow (e.g., a workflow that the system 200 has previously processed), then the system 200 makes predictions to the performance of that workflow using a pre-trained offline workflow model. The pre-trained offline workflow model can be used to predict the system state with the given workflow and determined scheduling information accordingly. In some implementations, a workflow model incorporates knowledge about and evaluates an entire workflow (aggregated from all tasks which could be dynamically invoked into a workflow), as compared to evaluating individual tasks/workloads of the workflow.

If the workflow kernels 214 are from an unknown workflow (e.g., a workflow that the system 200 has not previously processed), then the system will not have a pre-trained offline workflow model to utilize for scheduling. Instead, a profiling and learning system is running substantially continuously during execution of the workflow to profile and analyze the workflow that is being run in order to determine what would happen if the workflow were scheduled in one or more specified systems. Specifically, data from the profiling is fed to an online learning model, which may be updated in real time. Scheduling decisions for the workflow may be based on what is observed for the workflow and the state of the online learning model. At the end, data from the online learning model is used to generate a new pre-trained offline workflow model; the pre-trained model can then be persisted and used offline when a new workflow is submitted.

An online learning model adjusts its internal state as data is observed (allowing it to react to observations) and does not rely solely on previously collected data. An example of an online learning model is a reinforcement learning agent. A reinforcement learning agent observes data as it is produced, has an action space (which is a set of actions it can perform), and receives rewards (which are feedback from those actions). Applied to scheduling, the action space of a reinforcement learning agent includes scheduling tasks on specific compute nodes and partitioning available hardware (or components of the compute nodes) between tasks, while the rewards received from each action are measurements of system and task state such as time to completion, power consumption, and system load.

As will be appreciated from the foregoing, task scheduling for a workflow is guided by predictions of runtime and resource utilization made by online or offline models. An online model may be a reinforcement learning agent that is trained online for unknown tasks, providing real-time, adaptive scheduling decisions as the workflow executes. An offline model may be a pre-trained model that was generated from previous execution(s) of the workflow, offering and relevant insights for known tasks. This hybrid approach allows for real-time profiling and scheduling, adapting to the current system state and workload demands.

Between different steps of the workflow, there is the potential for movement of a large quantity of data on and off different accelerators within the system 200. Bandwidth may limit how much data can be moved at one time which, depending on the workflow and the timing, could cause different performance bottlenecks. Bottlenecks decrease the efficiency of the use of the compute resources by causing some resources to be idle while they wait for the bottleneck to be cleared. By utilizing pre-trained offline workflow models for known workflows as well as profiling and training new workflow models in real time during execution of a workflow for unknown workflows, the scheduler may allocate the available resources to the various workflows in a manner that substantially minimizes bottlenecks, which result in a better use of compute resources and substantially minimizes idle time for the various computer resources.

Furthermore, a workload or task may not saturate the compute resources of the compute nodes, which would result in idle resources. To alleviate this issue, the scheduler may allocate multiple workloads or tasks to be executed simultaneously. However, when multiple workloads or tasks are scheduled at the same time, there is the potential for them to interfere with one another. By not only utilizing pre-trained offline workflow models to determine what, how, and the quantity of compute resources utilized at different points in a workflow execution, but also profiling unknown workflows to obtain metrics in real time that may be used to predict the future needs of the unknown workflow, the available compute resources may be more efficiently utilized to substantially minimize idle time for a compute resource while also ensuring that the various workflows execute and complete efficiently.

Example workflows include scientific applications submitted by users running their own experiments. Each experiment may include a set of code bases that are used by the users working on that experiment. For example, researches in fields like physics or molecular dynamics may be running codes on the data they obtained from an experiment and the workflow for these users may be a series of simulations or data analyses that may include large amounts of data and that may require large amounts of compute resources to process. So, this workflow may include a number of tasks that are run in a certain sequence. The compute resources include computer resources like GPUs 204 that are suited for specific tasks and CPUs 208 or CPU cores that may be utilized for other tasks for which the GPU is not as suitable for performing or that do not need the speed that the GPUs 204 may provide.

The workflow scheduler allocates and schedules compute resources that are sufficient to perform the workflow submitted by the users. However, the workflow submitted, for example, by the users will not normally be the only workflow for which the scheduler must allocate compute resources. Thus, in allocating the compute resources, the scheduler may make a trade off between efficiency for a specific workflow and full use of available resources. In some cases, a workflow may require the utilization of an entire compute node, but in others, several workflows may be sharing compute resources on a compute node in order to make the most efficient use of the available compute resources. Additionally, the available compute resources may include a heterogeneous mix of different kinds of compute cores that may be running a sequence of tasks, such as a sequence of scientific calculation tasks. Furthermore, a workflow may behave differently on different types of compute resources, thus it is also desirable to know how a particular workflow will behave on a specific set of compute resources.

In some implementations, the runtime profiling tag generator 202 pads the workflow kernels 214 from user-submitted workflows with profiling tags so that the tags can feedback information to the online profiling metric aggregator 210. The runtime profiling tag generator 202 is configured to pad the workflow kernels 214 by automatically inserting profiling tags before or after the workflow kernels 214 at setup time, potentially at the compiler or scheduler level, without requiring user intervention. These tags enable the system to track the execution progress of kernels in real-time, providing granular data for the online learning model to make informed scheduling decisions. For example, the compiler/scheduler can add custom code snippets that track loop progress variables or a number of variables of an input buffer that were read to determine execution stage versus total execution time on the computation device (e.g., GPU, FPGA, CPU, etc.). The online profiling metric aggregator 210 may track the type of tags that are executed out of each kernel and memory regions where the tags reside, so that it may derive relationships for online profiling. In an example implementation, the profiling tags are agnostic to devices and work across different vendor accelerators and programs. An example profiling tag snippet that may be inserted before or after one of the workflow kernels 214 is provided below:
if (i==MAX_Elements/2)
   send_half_way_profiling_tag ( )
elseif (i==MAX_Elements*¾)
   send_75% _way_point_profiling_tag ( )
else (i==MAX_Elements)
   send_100% _way_point_profiling_tag ( )

The forgoing example determines an execution phase using the array index (“i”) of an input array, which is related to the maximum size of the array (“MAX_Elements”). That is, the profiling tag performs loop tracking to track the progress of a kernel through the processing of an array. However, other types of profiling tags could be utilized, especially when different loop sizes or data accesses make loop tracking complex or infeasible.

The profiling tags may be (device/host) buffers that would be exposed to the online-profile and may determine real-time scheduling of workflow and allocation of compute resources, such as GPUs 204, FPGAs 206, and CPUs 208. The profiling tags enable application-level augmentation to include code status tags upstream of a scheduler so that the scheduler is aware of where the GPU 204, FPGA 206, or CPU 208 is for the current workflow execution and can proactively schedule the next task based on where the GPU 204, FPGA 206, or CPU 208 is for the current workflow execution. In an example implementation, that tag interval information is used to profile the execution time of a task on a particular hardware component of a compute node. The compute resources may include other devices other than GPU 204, FPGA 206, and CPU 208. For example, the compute resources may include memory devices or non-volatile storage devices. The profiling tags link profiling data to overall workflow execution.

The online profiling metric aggregator 210 collects the information from the workflow kernels 214 (using the profiling tags), extracts metrics from the information, and provides the metrics to an online profiler 212 which uses the metrics to generate a model for the workflow, which can be stored for later use. The generated workflow model can then be used by a scheduler the next time this workflow is submitted in order to efficiently allocate GPU 204, FPGA 206, and CPU 208 resources. Additionally, the online-profiler may train a real time learning agent which can make suggestions for real time resource allocation to a scheduler during execution of the workflow. The scheduler may make use of the suggestions to allocate compute resources to remaining unexecuted workflow kernels 214.

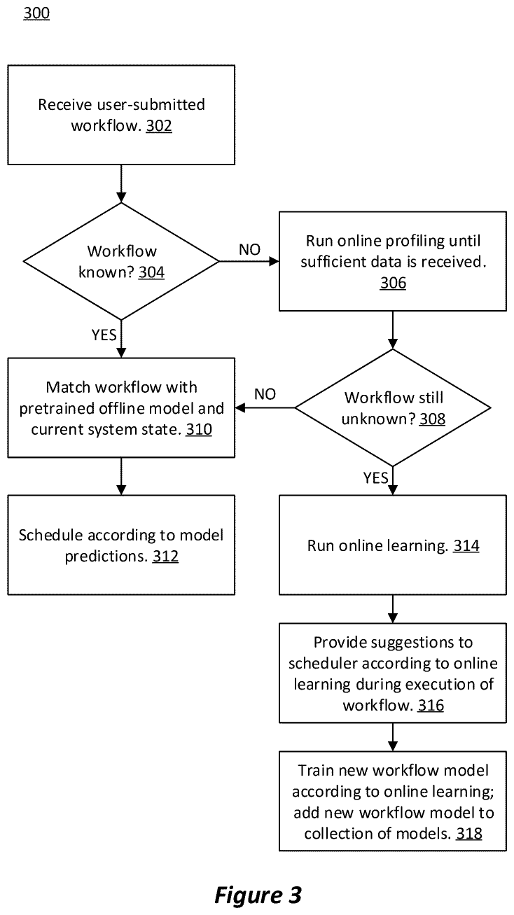

FIG. 3 provides a flowchart of a workflow resource allocation method 300, according to some implementations. The workflow resource allocation method 300 may be computer-implemented, such as by the scheduler node 104 described for FIG. 1.

The scheduler receives a user-submitted workflow (operation 302). The user-submitted workflow includes a plurality of kernels to be executed by the compute resources managed by the scheduler. The scheduler determines if the workflow is known (operation 304). If the workflow is not known, then the scheduler runs online profiling until sufficient data is received (operation 306). The amount of data that constitutes sufficient data varies by implementation, but in an example implementation, a sufficient amount of data is data that allows the scheduler to determine or make an educated guess as to the identity of the workflow. If the workflow is not still unknown (operation 308), the scheduler matches the workflow with one of the pre-trained offline workflow models and current system state (operation 310) and then schedules compute resources for the user-submitted workflow according to the predictions of the pre-trained offline workflow model (operation 312).

If the workflow is still unknown (operation 308), then the scheduler runs online learning (operation 314) to train a learning agent. The scheduler then provides suggestions to the scheduler according to online learning during execution of the user-submitted workflow (operation 316). The scheduler then trains a new workflow model according to the online learning and adds the new workflow model to the collection of pre-trained models for subsequent offline use (operation 318).

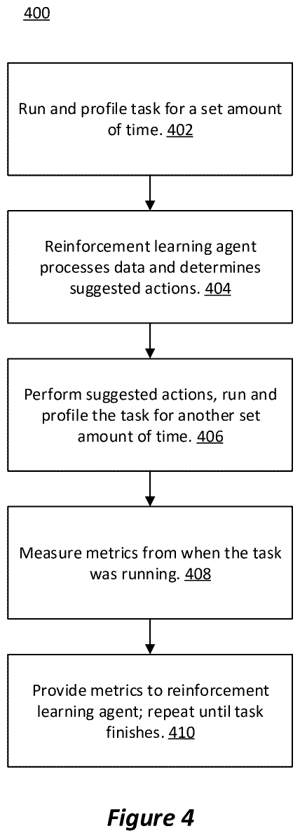

FIG. 4 provides a flowchart of a workflow learning method 400, according to some implementations. The workflow learning method 400 may be computer-implemented, such as by the scheduler node 104 described for FIG. 1. Specifically, the workflow learning method 400 may be implemented in operation 314 in FIG. 3.

A task from a workload is run and profiled for a set amount of time, e.g., 10 seconds (operation 402). A reinforcement learning agent is used to process data (e.g., metrics extracted using the aforementioned profiling tags) and determine suggested actions for scheduling (operation 404). For example, after a kernel is executed by an accelerator, execution of the workflow may be temporarily paused; based on the metrics, the reinforcement learning agent may suggest where/how to execute the next kernel in the workflow. The suggested actions are performed, then the task is run again and profiled for another set amount of time (operation 406). Various metrics from when the task was running, such as, for example, compute node memory, CPU load, accelerator memory, and compute load, are measured (operation 408). Those metrics are provided back to the reinforcement learning agent and the workflow learning method 400 is repeated until the task is finished (operation 410). The reinforcement learning agent may be a machine learning algorithm that is not pre-trained, but learns in real time as various metrics and data are collected.

Subsequently, data from the reinforcement learning agent may be used to generate a model for the workflow. The workflow model may be stored for later offline use. Optionally, the workflow model may be updated when later used. For example, a task from a subsequent workload may be run and profiled. Data (e.g., metrics extracted using the aforementioned profiling tags) may be collected during execution of the task.

The workflow model may then be revised based on the metrics collected when executing the task of the subsequent workload.

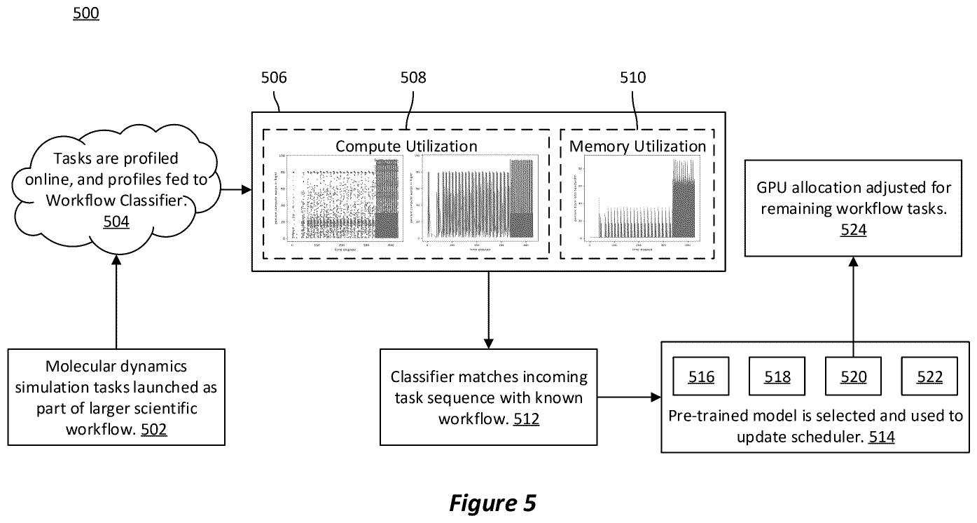

FIG. 5 is a schematic diagram of an example scenario 500 for utilizing the disclosed systems and methods. Molecular dynamics simulation tasks are launched as part of a larger scientific workflow (operation 502). Tasks are profiled online and profiles 506 are fed to a workflow classifier (operation 504). A workflow classifier may be a scheduler node running the workflow resource allocation method 300 previously described for FIG. 3. The profiles 506 may include compute utilization 508 and memory utilization 510. The workflow classifier matches incoming task sequence with a known workflow (operation 512). A pre-trained offline workflow model 520 is selected from a plurality of pre-trained offline workflow models 516, 518, 520, 522 and used to update the scheduler (operation 514). In this example, a GPU allocation is adjusted for the remaining workflow tasks (operation 524).

Some variations are contemplated. In some embodiments, knowledge data generated over time can enable tasks to be run where data is generated rather than transferring massive data to compute nodes. Models (e.g., pre-trained offline workflow models) can be used to determine whether local compute resources are sufficient to run tasks. For example, data may be collected at remote sensors (e.g., Rubin observatory telescope) and default tasks may be launched for preprocessing streaming data and further processing on off-site HPC clusters. A workflow to process the data may be submitted for processing. The workflow may be classified off-site (e.g., by a scheduler) and processed as previously described. Alternatively, if it is determined that current hardware resources available at the pre-processing site are sufficient, the data may be processed where it is being collected, particularly when doing so would be more optimal than transferring data to an off-site HPC cluster for processing.

In another example scenario, a scientific simulation workflow launches multiple GPU tasks in parallel on multiple compute nodes. The workflow may be classified and a pre-trained offline workflow model is used to provide an optimal partition of the GPU based on a predicted future workflow task load. The pre-trained offline workflow model may be identified as previously described.

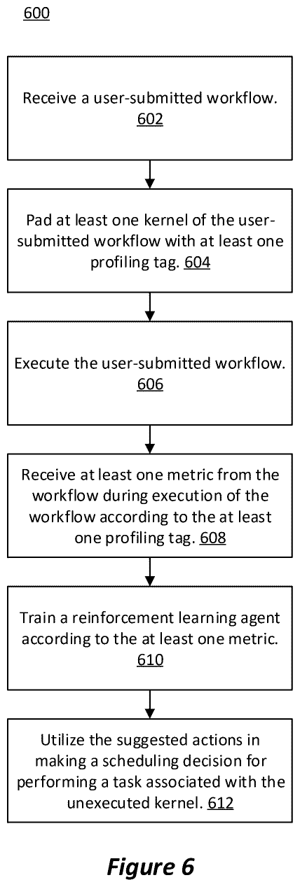

FIG. 6 provides a flowchart of a scheduling method 600, according to some implementations. The scheduling method 600 may be computer-implemented, such as by the scheduler node 104 described for FIG. 1.

The scheduler receives a user-submitted workflow (operation 602). The user-submitted workflow includes a plurality of kernels. The scheduler pads at least one kernel of the user-submitted workflow with at least one profiling tag (operation 604). The padding may be performed using a runtime profiling tag generator configured to operate at a compiler or scheduler level without user intervention. The scheduler begins executing the user-submitted workflow on a compute node (such as a compute node 102 described for FIG. 1) (operation 606). During execution of the user-submitted workflow, the scheduler receives at least one metric from the workflow according to the at least one profiling tag (operation 608). The at least one metric may include a real-time metric. The scheduler trains a reinforcement learning agent according to the at least one metric (operation 610). The reinforcement learning agent may be trained in real-time, and optionally may also be trained according to the current hardware configuration. The scheduler utilizes the suggest actions in making a scheduling decision for performing a task associated with the unexecuted kernel within the plurality of kernels while the user-submitted workflow continues executing (operation 612). The scheduling decision may comprise a computing resource allocation for executing the task. The computing resource allocation may be dynamically adapted based on the real-time profiling.

In an example implementation, the scheduling method 600 further provides that an offline workflow model is produced based on the reinforcement learning agent and the offline workflow model is stored or persisted to be available for utilization by the workflow resource scheduler, should this workflow be received in the future.

In an example implementation, the scheduling method 600 further provides a second user-submitted workflow is received, wherein the second user-submitted workflow is a known workflow. The scheduler then makes a second scheduling decision for performing a second task associated with the second user-submitted workflow based on the offline workflow model associated with the known second user-submitted workflow. In an example implementation, the offline workflow model utilized for the second user-submitted workflow is revised based on a second metric associated with execution of the second user-submitted workflow, wherein the second metric is obtained during execution of the second user-submitted workflow.

In an example implementation, the scheduling method 600 further provides that the at least one profiling tag links profiling data to overall workflow execution. In an example implementation, the at least one metric comprises a code status indicating a status of one of a graphics processing unit (GPU) or a central processing unit (CPU) for a current workflow execution. In an example implementation, the at least one metric comprises an execution time of the task on a hardware device.

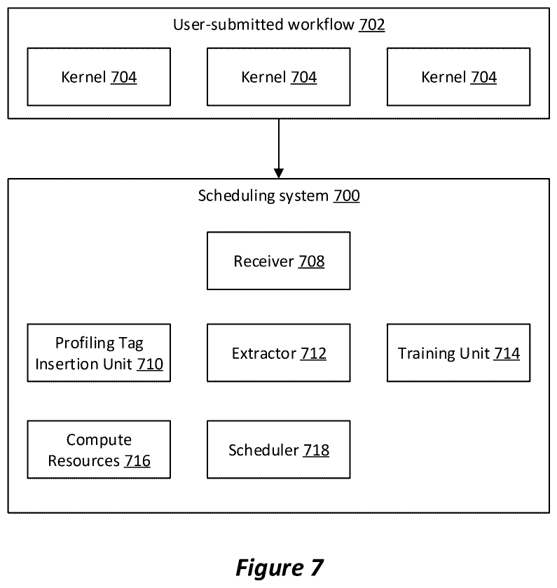

FIG. 7 provides a block diagram of a scheduling system 700, according to some implementations. The scheduling system 700 may be used for user-submitted workflow resource allocation. Functionality of the scheduling system 700 may be implemented by the scheduler node 104 described for FIG. 1.

The scheduling system 700 includes a receiver 708, a profiling tag insertion unit 710, an extractor 712, a training unit 714, a compute resources 716, and a scheduler 718. The receiver 708 is configured to receive a user-submitted workflow 702, wherein the user-submitted workflow 702 includes a plurality of kernels 704. The profiling tag insertion unit 710 is configured to pad at least one kernel 704 of the user-submitted workflow 702 with at least one profiling tag. The compute resources 716 are configured to execute the user-submitted workflow 702 on a compute node (such as a compute node 102 described for FIG. 1). The compute resources 716 may include a number of CPUs, GPUs, and/or FPGAs. The extractor 712 is configured to extract at least one metric from the workflow during execution of the workflow according to the at least one profiling tag. The training unit 714 is configured to train a reinforcement learning agent according to the at least one metric, wherein the reinforcement learning agent determines a suggested action for a particular type of kernel according to the at least one metric. The scheduler 718 is configured to utilize the suggested actions in making a scheduling decision for performing a task associated with an unexecuted kernel within the plurality of kernels 704 while the user-submitted workflow 702 continues executing, wherein the scheduling decision comprises an allocation of the compute resource 716 for executing the task.

In an example implementation, the scheduling system 700 includes a model creation unit configured to produce an offline workflow model based on the reinforcement learning agent and a non-volatile memory configured to store the offline workflow model.

In an example implementation, an offline workflow model is produced based on the reinforcement learning agent and the offline workflow model is stored or persisted in a non-volatile storage unit to be available for utilization by the scheduler should the user-submitted workflow 702 be received in the future.

In an example implementation, the receiver 708 is further configured to receive a second user-submitted workflow, wherein the second user-submitted workflow is a known workflow. The scheduler 718 then makes a second scheduling decision for performing a second task associated with the second user-submitted workflow based on the offline workflow model associated with the known second user-submitted workflow. In an example implementation, the offline workflow model utilized for the second user-submitted workflow is revised based on a second metric associated with execution of the second user-submitted workflow, wherein the second metric is obtained during execution of the second user-submitted workflow.

In an example implementation, the at least one profiling tag links profiling data to overall workflow execution. In an example implementation, the at least one metric comprises a code status indicating a status of one of a GPU or CPU for a current workflow execution. In an example implementation, the at least one metric comprises an execution time of the task on a hardware device.

Although this disclosure describes or illustrates particular operations as occurring in a particular order, this disclosure contemplates the operations occurring in any suitable order. Moreover, this disclosure contemplates any suitable operations being repeated one or more times in any suitable order. Although this disclosure describes or illustrates particular operations as occurring in sequence, this disclosure contemplates any suitable operations occurring at substantially the same time, where appropriate. Any suitable operation or sequence of operations described or illustrated herein may be interrupted, suspended, or otherwise controlled by another process, such as an operating system or kernel, where appropriate. The acts can operate in an operating system environment or as stand-alone routines occupying all or a substantial part of the system processing.

While this disclosure has been described with reference to illustrative implementations, this description is not intended to be construed in a limiting sense. Various modifications and combinations of the illustrative implementations, as well as other implementations of the disclosure, will be apparent to persons skilled in the art upon reference to the description. It is therefore intended that the appended claims encompass any such modifications or implementations.

What is claimed is:

1. A computer-implemented method comprising:
receiving a user-submitted workflow comprising a plurality of kernels;
padding at least one kernel of the user-submitted workflow with at least one profiling tag;
executing the user-submitted workflow on a compute node;
receiving at least one metric from the user-submitted workflow during execution of the user-submitted workflow according to the at least one profiling tag;
training a reinforcement learning agent according to the at least one metric, wherein the reinforcement learning agent determines a suggested action for a particular type of kernel according to the at least one metric; and
utilizing the suggested actions in making a scheduling decision for performing a task associated with an unexecuted kernel within the plurality of kernels while the user-submitted workflow continues executing, wherein the scheduling decision comprises a computing resource allocation for executing the task.

2. The method of claim 1, further comprising:
producing an offline workflow model based on the reinforcement learning agent; and
persisting the offline workflow model.

3. The method of claim 2, further comprising:
receiving a second user-submitted workflow; and
making a second scheduling decision for performing a second task associated with the second user-submitted workflow based on the offline workflow model.

4. The method of claim 3, further comprising:
revising the offline workflow model based on a second metric associated with execution of the second user-submitted workflow, wherein the second metric is obtained during execution of the second user-submitted workflow.

5. The method of claim 1, wherein the at least one profiling tag links profiling data to overall workflow execution.

6. The method of claim 1, wherein the at least one metric comprises a code status indicating a status of one of a graphics processing unit (GPU) or a central processing unit (CPU) for a current workflow execution.

7. The method of claim 1, wherein the at least one metric comprises an execution time of the task on a hardware device.

8. A non-transitory computer readable medium storing instructions which, when executed by a processor, cause the processor to:
receive a user-submitted workflow comprising a plurality of kernels;
pad at least one kernel of the user-submitted workflow with at least one profiling tag;
execute the user-submitted workflow on a compute node;
receive at least one metric from the user-submitted workflow during execution of the user-submitted workflow according to the at least one profiling tag;
train a reinforcement learning agent according to the at least one metric, wherein the reinforcement learning agent determines a suggested action for a particular type of kernel according to the at least one metric; and
utilize the suggested actions in making a scheduling decision for performing a task associated with an unexecuted kernel within the plurality of kernels while the user-submitted workflow continues executing, wherein the scheduling decision comprises a computing resource allocation for executing the task.

9. The non-transitory computer readable medium of claim 8, further comprising instructions which, when executed by the processor, cause the processor to:
produce an offline workflow model based on the reinforcement learning agent; and
persist the offline workflow model.

10. The non-transitory computer readable medium of claim 9, further comprising instructions which, when executed by the processor, cause the processor to:
receive a second user-submitted workflow; and
make a second scheduling decision for performing a second task associated with the second user-submitted workflow based on the offline workflow model.

11. The non-transitory computer readable medium of claim 10, further comprising instructions which, when executed by the processor, cause the processor to:
revise the offline workflow model based on a second metric associated with execution of the second user-submitted workflow, wherein the second metric is obtained during execution of the second user-submitted workflow.

12. The non-transitory computer readable medium of claim 8, wherein the at least one profiling tag links profiling data to overall workflow execution.

13. The non-transitory computer readable medium of claim 8, wherein the at least one metric comprises a code status indicating a status of one of a graphics processing unit (GPU) or central processing unit (CPU) for a current workflow execution.

14. The non-transitory computer readable medium of claim 8, wherein the at least one metric comprises an execution time of the task on a hardware device.

15. A system comprising:
a compute node; and
a scheduler node configured to:
receive a user-submitted workflow comprising a plurality of kernels;
pad at least one kernel of the user-submitted workflow with at least one profiling tag;
execute the user-submitted workflow on the compute node;
receive at least one metric from the user-submitted workflow during execution of the user-submitted workflow according to the at least one profiling tag;
train a reinforcement learning agent according to the at least one metric, wherein the reinforcement learning agent determines a suggested action for a particular type of kernel according to the at least one metric; and
utilize the suggested actions in making a scheduling decision for performing a task associated with an unexecuted kernel within the plurality of kernels while the user-submitted workflow continues executing, wherein the scheduling decision comprises a computing resource allocation for executing the task.

16. The system of claim 15, wherein the scheduler node is further configured to:
produce an offline workflow model based on the reinforcement learning agent; and
persist the offline workflow model.

17. The system of claim 16, wherein the scheduler node is further configured to:
receive a second user-submitted workflow; and
make a second scheduling decision for performing a second task associated with the second user-submitted workflow based on the offline workflow model.

18. The system of claim 15, wherein the at least one profiling tag links profiling data to overall workflow execution.

19. The system of claim 15, wherein the compute node comprise an accelerator, and the at least one metric comprises a code status indicating a status of the accelerator for a current workflow execution.

20. The system of claim 15, wherein the at least one metric comprises an execution time of the task on a component of the compute node.
